(19) United States
(12) Patent Application Publication
(10) Pub. No.: US 2025/0258031 A1
(43) Pub. Date: Aug. 14, 2025

(54) LIQUID LEVEL DETECTION DEVICE

(71) Applicant: TOTOTA JIDOSHA KABUSHIKI KAISHA, Toyota-shi (JP)

(72) Inventors: Yuki BISAIJI, Tokyo (JP); Takuro Mizushima, Sunto-gun (JP)

(73) Assignee: TOTOTA JIDOSHA KABUSHIKI KAISHA, Toyota-shi (JP)

(21) Appl. No.: 18/966,832

(22) Filed: Dec. 3, 2024

(30) Foreign Application Priority Data
Feb. 13, 2024 (JP) 2024-019705

(51) Int. Cl. G01F 23/24

(52) U.S. Cl. CPC G01F 23/247

(57) ABSTRACT

The liquid level detection device includes a temperature sensor disposed at a predetermined position in a tank for storing liquid hydrogen, a heater capable of raising an ambient temperature at the predetermined position, a liquid level detection unit for detecting whether the liquid level of the liquid hydrogen in the tank has reached the predetermined position based on a change in a temperature detected by the temperature sensor, and a heater state determination unit for determining whether an abnormality is caused in the state of the heater. The heater state determination unit is configured to be capable of executing a temperature raising process for raising the ambient temperature, and a determination process for determining that the state of the heater is abnormal when an increase exceeding a predetermined temperature range does not occur in the detected temperature within a predetermined time after the temperature raising process is started.

### CROSS-REFERENCE TO RELATED APPLICATION

This application claims priority to Japanese Patent Application No. 2024-019705 filed on Feb. 13, 2024, incorporated herein by reference in its entirety.

### BACKGROUND

### 1. Technical Field

The technique disclosed herein relates to a technique of detecting a liquid level of liquid hydrogen stored in a tank.

### 2. Description of Related Art

When liquid hydrogen is filled in a tank for storing liquid hydrogen, it is necessary to detect that a predetermined amount of liquid hydrogen has accumulated. Japanese Unexamined Patent Application Publication No. 2014-98659 (JP 2014-98659 A) discloses, as a related art, a technique of measuring a liquid level of liquid hydrogen stored in a heat insulating container using a liquid hydrogen level sensor.

### SUMMARY

A sensor disposed in a tank detects the liquid level of the liquid hydrogen in the tank based on a temperature change caused by a liquid surface touching the sensor. In order to improve the accuracy of such detection, a heater that increases the ambient temperature is provided in the tank. However, it is not determined whether the state of the heater is normal or abnormal. A reliable detection result cannot be obtained if liquid level detection is executed while it is unknown whether the heater is abnormal.

An aspect of the present specification discloses a liquid level detection device.
The liquid level detection device includes:
a temperature sensor disposed at a predetermined position in a tank that stores liquid hydrogen;
a heater capable of raising an ambient temperature at the predetermined position in the tank;
a liquid level detection unit that detects whether a liquid level of the liquid hydrogen in the tank has reached the predetermined position based on a change in a temperature detected by the temperature sensor; and
a heater state determination unit that determines whether a state of the heater is abnormal. The heater state determination unit is configured to be able to execute:
a temperature increasing process of increasing the ambient temperature using the heater; and
a determination process of determining that the state of the heater is abnormal when the detected temperature is not increased by more than a predetermined temperature range within a predetermined time after the temperature increasing process is started.

According to the above configuration, the heater state determination unit of the liquid level detection device determines that the state of the heater is abnormal when the detected temperature is not increased by more than a predetermined temperature range within a predetermined time after the temperature increasing process is started. Thus, the liquid level detection device can recognize an abnormality of the heater.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration including a liquid level detection device;

FIG. 2 is a flow chart showing a process executed by ECU; and

FIG. 3 is a graph illustrating a change in a temperature detected by a temperature sensor.

### DETAILED DESCRIPTION OF EMBODIMENTS

Embodiments will be described with reference to the drawings. Each of the drawings is merely an example, and the present embodiment is not limited to the illustrated contents. In addition, since each of the drawings is an example, the illustrated shape is not accurate or a part thereof is omitted.

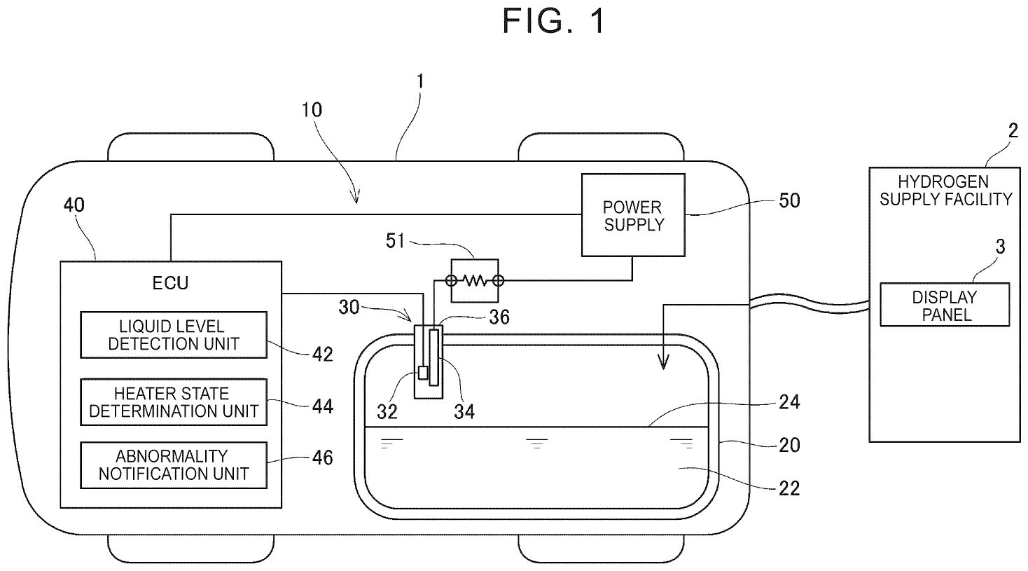

FIG. 1 schematically illustrates a configuration including a liquid level detection device 10 according to the present embodiment. The liquid level detection device 10 and the tank 20 are mounted on, for example, a vehicle 1 that can travel using hydrogen as a fuel. The tank 20 is a tank for storing the liquid hydrogen 22, and has a structure of a vacuum double shell. A vehicle traveling by a fuel cell, a vehicle traveling by a hydrogen engine, or the like corresponds to the vehicle 1. However, the liquid level detection device 10 and the tank 20 may be not only mounted on a moving unit such as the vehicle 1, but also may be a part of equipment installed in various places. The liquid hydrogen 22 is supplied to the tank 20 from an external hydrogen supply facility 2.

The liquid level detection device 10 includes a sensor unit 30 disposed in the tank 20, an ECU 40 as a control unit, and a power supply 50. The tank 20 may be included in a part of the liquid level detection device 10 to be interpreted. ECU is an abbreviation for Electronic Control Unit. ECU 40 is one of various ECU mounted on the vehicle 1. The sensor unit 30 includes, for example, a temperature sensor 32 and a heater 34 held by a holding member 36 such as a predetermined bracket or casing.

The temperature sensor 32 is a means for detecting the temperature, and is, for example, a thermocouple. The temperature sensor 32 is disposed at a “predetermined position” in the tank 20. In the present embodiment, this predetermined position is also regarded as an example of the filling completion position of the liquid hydrogen 22. That is, when the liquid level 24 of the liquid hydrogen 22 reaches a predetermined position where the temperature sensor 32 is disposed, the filling of the liquid hydrogen 22 into the tank 20 is completed, and the tank 20 becomes full.

When a current is supplied from the power supply 50 to the heater 34 via the resistor 51, the heater 34 generates heat. In addition, the amount of heat generated by the heater 34 varies according to the amount of current supplied to the heater 34. The heater 34 is capable of raising the ambient temperature at a predetermined position in the tank 20. “Increasing the ambient temperature at a predetermined position” does not mean that only the temperature at the predetermined position is increased, but also means that the temperature in the range including the temperature sensor 32 disposed at the predetermined position and the gas in the vicinity of the temperature sensor 32 is increased. The detected temperature detected by the temperature sensor 32 is outputted to ECU 40.

ECU 40 includes functional units such as a liquid level detection unit 42, a heater state determination unit 44, and an abnormality notification unit 46. The liquid level detection unit 42 can detect whether the liquid level 24 of the liquid hydrogen 22 in the tank 20 has reached a predetermined position based on a change in the temperature detected by the temperature sensor 32. The liquefaction temperature of the hydrogen is about −253° C. (20 K). Therefore, the liquid level detection unit 42 compares the detected temperature with a predetermined threshold value (first threshold value) set in the vicinity of the liquefied temperature. Then, the liquid level detection unit 42 detects a state in which the liquid hydrogen 22 is not in contact with the temperature sensor 32 when the detected temperature exceeds the first threshold value, that is, detects a state in which the liquid level 24 does not reach the predetermined position. The liquid level detection unit 42 detects a state in which the liquid level 24 reaches a predetermined position when the detected temperature is lower than the first threshold value.

However, in the tank 20, the vicinity of the liquid level 24 may be cooled to an air temperature close to the liquefaction temperature. In addition, a part of the liquid hydrogen 22 may temporarily adhere to the temperature sensor 32 due to the swing of the liquid level 24. For these reasons, it may not be possible to accurately detect whether the liquid level 24 has reached a predetermined position. From this point of view, a heater 34 is provided. That is, in a situation where the liquid level 24 does not reach the temperature sensor 32, the temperature detected by the temperature sensor 32 surely exceeds the first threshold value due to the temperature raising effect by the heater 34. However, it is assumed that the heater 34 operates normally. If there is an abnormality in the heater 34, the detection result by the liquid level detection unit 42 based on the temperature detected by the temperature sensor 32 becomes unreliable. Therefore, in the present embodiment, as described below, the heater state determination unit 44 determines whether the state of the heater 34 is abnormal.

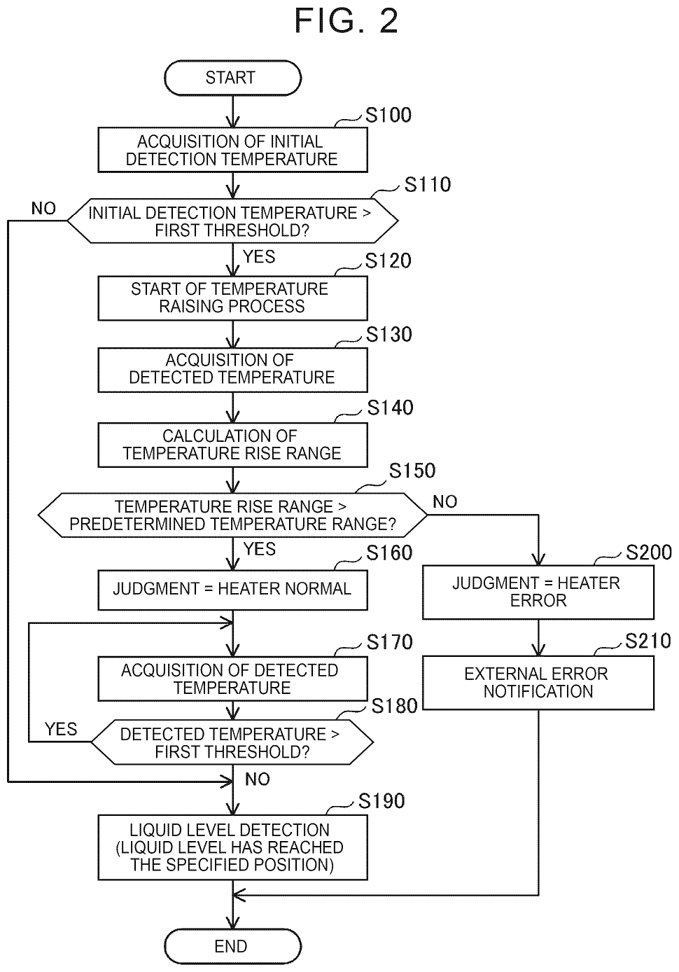

FIG. 2 is a flow chart illustrating a process executed by ECU 40 in the present embodiment. When ECU 40 recognizes that the supply of the liquid hydrogen 22 from the hydrogen supply facility 2 to the tank 20 is started, the flow chart starts.

In S100, the heater state determination unit 44 acquires the detected temperature from the temperature sensor 32. The detected temperature acquired by S100 is referred to as an early detected temperature. Then, in S110, the heater state determination unit 44 determines whether the initially detected temperature exceeds the first threshold. The heater state determination unit 44 proceeds from the determination of “Yes” of S110 to S120 when the initial detected temperature exceeds the first threshold, and proceeds from the determination of “No” of S110 to S190 when the initial detected temperature falls below the first threshold.

When the initial detected temperature is lower than the first threshold, the heater state determination unit 44 assumes that the liquid level 24 is in contact with the temperature sensor 32, and proceeds to S190 without executing a determination process described later. In S110 and $150, S180 to be described later, the values to be compared rarely coincide with each other, but in such cases, the flow chart may be designed to branch to either “Yes” or “No”.

In S120, the heater state determination unit 44 outputs an operation instruction of the heater 34 to the power supply 50, and causes the power supply 50 to operate the heater 34. The heater state determination unit 44 starts a temperature raising process of raising the ambient temperature at a predetermined position to the heater 34 by S120. Note that S120 timing is not limited to the timing after S110, and may be, for example, the timing after S100 and before S110, or may be the timing in parallel with S110.

The heater state determination unit 44 acquires the detected temperature from the temperature sensor 32 at a timing when a predetermined time has elapsed from S120 (S130). Here, the predetermined time is, for example, about 10 seconds. In S140, the heater state determination unit 44 calculates a difference (increased temperature range) obtained by subtracting the initial-detected temperature from the detected temperature acquired by S130.

In S150, the heater state determination unit 44 determines whether the rising temperature range exceeds a predetermined temperature range. The heater state determination unit 44 proceeds from the determination of “Yes” of S150 to S160 when the rising temperature range exceeds the predetermined temperature range, and proceeds from the determination of “No” of S150 to S200 when the rising temperature range does not exceed the predetermined temperature range. Since the rising temperature range is assumed to be a positive value, the predetermined temperature range is also a positive value. If the temperature-rise range is negative, the determination of S150 is naturally “No”.

In S160, the heater state determination unit 44 determines that the state of the heater 34 is normal, and proceeds to S170. On the other hand, in S200, the heater state determination unit 44 determines that the state of the heater 34 is abnormal because the temperature increase by the heater 34 is insufficient, and proceeds to S210. S130, S140, S150, S160, S200 corresponds to an exemplary determination process. According to such determination processing, the heater state determination unit 44 determines that the state of the heater 34 is abnormal when an increase in the temperature detected by the temperature sensor 32 that exceeds the predetermined temperature range does not occur within a predetermined time after the start of the temperature increase processing.

Note that the heater state determination unit 44 may compare the rising temperature range with the predetermined temperature range not only at the timing (the timing of S130) at which the predetermined time has elapsed since S120, but also at one or more times, for example, every second, even prior to the lapse of the predetermined time. That is, during the period from S120 until the predetermined time elapses, the difference (increase temperature range) between the latest detected temperature acquired from the temperature sensor 32 at that time point and the initial detected temperature is calculated and compared with the predetermined temperature range. If the current temperature rise range is greater than the predetermined temperature range, the process may proceed to S160 prior to the elapse of the predetermined period.

The state leading to S170 corresponds to a case where the temperature detected by the temperature sensor 32 exceeds the first threshold value and the state of the heater 34 is not determined to be abnormal by the heater state determination unit 44. In S170, the liquid level detection unit 42 acquires the detected temperature from the temperature sensor 32. Then, in S180, the liquid level detection unit 42 determines whether the detected temperature obtained by S170 exceeds the first threshold.

The liquid level detection unit 42 returns to S170 from the determination of S180 “No” to S190 when the detected temperature acquired by S170 is lower than the first threshold, and from the determination of S180 “Yes” when the detected temperature acquired by S170 is higher than the first threshold. That is, the liquid level detection unit 42 repeats S170, S180 until it can be determined as “No” by S180. Such a S170, S180 corresponds to a process for detecting the liquid level 24.

In S190, the liquid level detection unit 42 detects that the liquid level 24 has reached the predetermined position, and the flow chart ends. When the flow chart is completed by S190, ECU 40 can, of course, stop supplying the liquid hydrogen 22. The specific method for stopping the supply of the liquid hydrogen 22 is not particularly limited. For example, ECU 40 instructs the hydrogen supply facility 2 to stop the supply of the liquid hydrogen 22 by wired or wireless communication with the hydrogen supply facility 2.

In S210, the abnormality notification unit 46 notifies the outside of the abnormality of the heater 34, and then ends the flow chart. The outside is not particularly limited, but is, for example, the hydrogen supply facility 2. The hydrogen supply facility 2 can stop the supply of the liquid hydrogen 22 to the tank 20 when a notification of an abnormality of the heater 34 is received from the abnormality notification unit 46. In addition, when receiving the notification of the abnormality of the heater 34, the hydrogen supply facility 2 may display, for example, a message indicating that an abnormality has occurred in the heater 34, a message indicating that the liquid level 24 in the tank 20 cannot be accurately detected, a message indicating that the supply of the liquid hydrogen 22 has been stopped, and the like on the display panel 3 or the like included in the hydrogen supply facility 2 to notify the user. The outside as the notification destination by the abnormality notification unit 46 may include not only the hydrogen supply facility 2 but also a terminal such as a computer or a smartphone registered in advance in the abnormality notification unit 46.

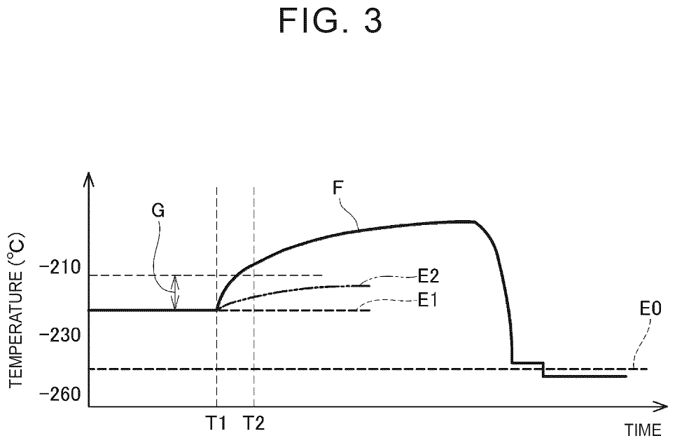

FIG. 3 graphically illustrates the change in the detected temperature F with respect to time by the temperature sensor 32. The temperature E0 corresponds to a first threshold. A specific example according to the above-described flowchart will be described with reference to FIG. 3. It is assumed that the detected temperature F as the initial detection temperature is a temperature E1 higher than the temperature E0 (S110 “Yes”), and the temperature raising process is started at the time T1 (S120). When the rise temperature range of the detected temperature F from the initial detection temperature at the time T2 at which the predetermined time has elapsed from the time T1 exceeds the predetermined temperature range G (S150 “Yes”), the heater state determination unit 44 determines that the state of the heater 34 is normal (S160). After that, the detected temperature F continues to increase due to the temperature raising effect by the heater 34, but when the position of the liquid level 24 rises and touches the temperature sensor 32, the detected temperature F rapidly decreases. When the detected temperature F falls below the temperature E0 (S180 “No”), the liquid level detection unit 42 detects that the liquid level 24 has reached the predetermined position (S190).

On the other hand, after the start (S120) of the temperature raising process in the time T1, for example, when the change in the detected temperature F takes a behavior such as a temperature E2 indicated by a two-dot chain line, the temperature rise range from the initial detected temperature does not exceed the predetermined temperature range G at the time T2 (S150 “No”) (temperature rise range=temperature E2−temperature E1). Then, the heater state determination unit 44 determines that the state of the heater 34 is abnormal (S200).

As described above, according to the present embodiment, the liquid level detection device 10 includes the temperature sensor 32 disposed at a predetermined position in the tank 20 that stores the liquid hydrogen 22, the heater 34 capable of raising the ambient temperature at the predetermined position in the tank 20, the liquid level detection unit 42 that detects whether or not the liquid level 24 of the liquid hydrogen 22 in the tank 20 has reached the predetermined position based on the change in the detected temperature by the temperature sensor 32, and the heater state determination unit 44 that determines whether or not the state of the heater 34 is abnormal. The heater state determination unit 44 is configured to execute a temperature raising process of raising the ambient temperature by the heater 34, and a determination process of determining that the state of the heater 34 is abnormal when an increase exceeding a predetermined temperature range does not occur in the detected temperature within a predetermined time after the start of the temperature raising process. According to the above configuration, the liquid level detection device 10 can recognize the abnormality when the abnormality occurs in the heater 34. Therefore, the liquid level detection device 10 can also avoid detecting whether the liquid level 24 has reached the predetermined position in an abnormal state of the heater 34.

Further, according to the present embodiment, in the determination process, the heater state determination unit 44 may determine whether or not an increase in the detected temperature exceeding the predetermined temperature range has occurred at least at a timing when the predetermined time has elapsed from the start of the temperature increase process.

According to the above configuration, the heater state determination unit 44 can determine the presence or absence of the abnormality with a small processing amount by executing, at the timing, a determination as to whether an increase in the detected temperature exceeding the predetermined temperature range has occurred.

In addition, according to the present embodiment, the heater state determination unit 44 may not execute the determination process when the detected temperature falls below a predetermined threshold value (first threshold value).
According to the above configuration, the heater state determination unit 44 can prevent the useless processing from being performed when the detected temperature is lower than the first threshold value and thus there is substantially no meaning of executing the determination processing.

In addition, according to the present embodiment, the liquid level detection unit 42 may start a process for detecting the liquid level 24 when the detected temperature exceeds the first threshold value and the heater state determination unit 44 does not determine that the state of the heater 34 is abnormal.

According to the above configuration, the liquid level detection unit 42 has a premise for detecting the liquid level 24, and after confirming that there is no abnormality in the heater 34, by starting the process for detecting the liquid level 24, thereafter, it is possible to accurately detect the liquid level 24.

In addition, according to the present embodiment, the liquid level detection device 10 may further include an abnormality notification unit 46 that notifies the outside of the abnormality when the heater state determination unit 44 determines that the state of the heater 34 is abnormal.
According to the above configuration, the liquid level detection device 10 can notify the outside that the state of the heater 34 is abnormal.

While specific examples of the technology disclosed herein have been described in detail above, these are merely illustrative and do not limit the scope of the claims. Various modifications and variations of the specific examples described above are included in the technology described in the claims. In addition, the technical elements described in the present specification or the drawings exhibit technical usefulness alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A liquid level detection device comprising:
a temperature sensor disposed at a predetermined position in a tank that stores liquid hydrogen;
a heater capable of raising an ambient temperature at the predetermined position in the tank;
a liquid level detection unit that detects whether a liquid level of the liquid hydrogen in the tank has reached the predetermined position based on a change in a temperature detected by the temperature sensor; and
a heater state determination unit that determines whether a state of the heater is abnormal, wherein the heater state determination unit is configured to be able to execute:
a temperature increasing process of increasing the ambient temperature using the heater; and
a determination process of determining that the state of the heater is abnormal when the detected temperature is not increased by more than a predetermined temperature range within a predetermined time after the temperature increasing process is started.

2. The liquid level detection device according to claim 1, wherein the heater state determination unit determines in the determination process whether the detected temperature is increased by more than the predetermined temperature range at least at a timing when the predetermined time has elapsed since the temperature increasing process is started.

3. The liquid level detection device according to claim 1, wherein the heater state determination unit does not execute the determination process when the detected temperature falls below a predetermined threshold value.

4. The liquid level detection device according to claim 3, wherein the liquid level detection unit starts a process of detecting the liquid level when the detected temperature exceeds the threshold value and the heater state determination unit does not determine that the state of the heater is abnormal.

5. The liquid level detection device according to claim 1, further comprising an abnormality notification unit that notifies an outside of an abnormality when the heater state determination unit determines that the state of the heater is abnormal.
